(19) United States
(12) Patent Application Publication
(10) Pub. No.: US 2026/0343270 A1
(43) Pub. Date: Oct. 29, 2026

(54) METHOD AND APPARATUS OF SUPPORTING QUALITY OF EXPERIENCE (QoE) MEASUREMENT COLLECTION

(71) Applicant: Lenovo (Beijing) Limited, Beijing (CN)

(72) Inventors: Mingzeng Dai, Shanghai (CN); Hyung-Nam Choi, Ottobrunn (DE); Congchi Zhang, Shanghai (CN); Lianhai Wu, Beijing (CN); Le Yan, Shanghai (CN); Shuigen Yang, Shanghai (CN)

(73) Assignee: Lenovo (Beijing) Limited, Beijing (CN)

(21) Appl. No.: 19/112,423

(22) PCT Filed: Sep. 27, 2022
(86) PCT No.: PCT/CN2022/121655

§ 371 Date: Mar. 17, 2025

(51) Int. Cl. H04W 24/08

(52) U.S. Cl. CPC H04W 24/08

(57) ABSTRACT

A method of supporting quality of experience (QoE) measurement collection may include: receiving first QoE configuration information from a first RAN node; receiving second QoE configuration information from a second RAN node; and transmitting duplication indication information to at least one of the first RAN node or the second RAN node in response to that the first QoE configuration information and the second QoE configuration information are associated with a same QoE measurement, wherein, the duplication indication information indicates that at least one of the first QoE configuration information or the second QoE configuration information is ignored due to the first and the second QoE configuration information being duplicated.

### TECHNICAL FIELD

Embodiments of the present application generally relate to wireless communication technology, especially to a method and apparatus of supporting quality of experience (QoE) measurement collection.

### BACKGROUND

Wireless communication systems are widely deployed to provide various telecommunication services such as telephony, video, data, messaging, broadcasts, and so on.. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In 3GPP release (Rel)-17, the basic mechanism for NR QoE is specified. Since NR-dual connectivity (DC) is an important commercial deployment scenario for 5G networks, it is critical to support NR-DC in the NR QoE framework. Therefore, QoE in Rel-18 will support QoE measurement configuration and measurement reporting for NR-DC scenario, as agreed below in RP-213159:
Specify the QoE configuration, and measurement reporting over MN/SN for NR-DC architecture and specify the QoE measurement reporting over the other DC leg in order to maintain the reporting continuity.

However, in some scenarios, e.g., management based QoE measurement in NR-DC, both master node (MN) and secondary node (SN) may receive the QoE measurement configurations from an operation administration and maintenance (OAM) system. If there is no co-ordination between MN and SN, some issues will happen. For example, the application layer of a user equipment (UE) may receive two identical application layer measurement configurations with different measConfigAppLayerIds for a QoE measurement configured by MN and SN respectively, which will cause QoE measurement failure in UE's application layer.

Given the above, the industry desires technology to improve QoE measurement collection, especially improving technology of supporting QoE measurement for NR-DC.

### SUMMARY OF THE APPLICATION

One objective of the embodiments of the present application is to provide a technical solution of supporting QoE measurement collection, e.g., a method and apparatus of supporting QoE measurement collection for NR-DC by coordinating the MN and SN or the like.

Some embodiments of the present application provide a UE, which includes: a transceiver; and a processor coupled to the transceiver. The processor is configured to: receive first QoE configuration information from a first radio access network (RAN) node; receive second QoE configuration information from a second RAN node; and transmit duplication indication information to at least one of the first RAN node or the second RAN node in response to that the first QoE configuration information and the second QoE configuration information are associated with a same QoE measurement. The duplication indication information indicates that at least one of the first QoE configuration information or the second QoE configuration information is ignored due to the first QoE configuration information and the second QoE configuration information being duplicated for a QE measurement.

In some embodiments of the present application, the first QoE configuration information and the second QoE configuration information are received respectively from the MN and SN by a radio resource control (RRC) layer of the UE. According to some embodiments of the present application, the first QoE configuration information and the second QoE configuration information are transmitted to an application layer of the UE by the RRC layer, and whether the first QoE configuration information and the second QoE configuration information are duplicated and which QoE configuration information will be ignored are determined by the application layer.

In some embodiments of the present application, the duplication indication information indicates that only one of the first QoE configuration information and the second QoE configuration information being duplicated is ignored with a RRC identifier of ignored QoE configuration information. According to some embodiments of the present application, the duplication indication information further indicates a RRC identifier of other one of the first QoE configuration information and the second QoE configuration information.

In some embodiments of the present application, the duplication indication information indicates that both the first QoE configuration information and the second QoE configuration information being duplicated are ignored with a RRC identifier of each ignored QoE configuration information.

In some embodiments of the present application, the duplication indication information is respectively transmitted to at least one of the first RAN node or the second RAN node associated with ignored QoE configuration information, or only transmitted to one as an MN of the first RAN node and the second RAN node.

In some embodiments of the present application, the first QoE configuration information indicates an MN index and measConfigAppLayerId, and the second QoE configuration information indicates an SN index and measConfigAppLayerId.

In some embodiments of the present application, in the case that anyone of the first QoE configuration information and the second QoE configuration information indicates information as RRC identifier for SNs, the corresponding QoE measurement information is configured by an SN.

In some embodiments of the present application, in the case that RVQUE measurement configuration information is also received, a RRC layer of the UE will select at least one leg of an MN and an SN to report RVQoE measurement results.

According to some embodiments of the present application, the RRC layer receives the RVQoE measurement results and identity information of at least one of data radio bearer (DRB), quality of service (QOS) flow or protocol data unit (PDU) session from an application layer of the UE. The RRC layer will select the at least one leg to report the RVQoE measurement results based on bearer types, wherein, in the case that the at least one of DRB, QoS flow or PDU session is served by only one of a master cell group (MCG) and a secondary cell group (SCG), the RRC layer will only report the RVQoE measurement results to corresponding one of the MN and the SN, and in the case that the at least one of DRB, QoS flow or PDU session is served by both MCG and SCG, the RRC layer will report the RVQoE measurement results to both the MN and SN.

According to some embodiments of the present application, the RRC layer will select the at least one leg to report the RVQoE measurement results based on reporting leg configuration information.

In some embodiments of the present application, the processor is configured to: receive RVQoE measurement configuration information, wherein the RVQoE configuration information indicates measConfigAppLayerId and one of an MN index and an SN index.

Some other embodiments of the present application provide a RAN node, e.g., an MN or an SN, which includes: a transceiver; and a processor coupled to the transceiver. The processor is configured to: receive information indicating at least one QoE measurement; and determine information associated with configurations of the at least one QoE measurement, wherein the information associated with configurations of the at least one QoE measurement includes at least one of: first information related to whether a same QoE measurement is configured to a UE by an MN or an SN, second information related to RRC identifiers for QoE measurements, or third information related to RRC identifiers for RVQoE measurements.

In some embodiments of the present application, the RAN node is an MN and a peer node is an SN, and the processor is configured to: receive QoE configuration request information to request whether a QoE measurement is allowed from the SN; and transmit the first information to the SN in response to the QoE configuration request information, wherein the first information is QoE configuration allowed indication information indicating that the QoE measurement is allowed or QoE configuration rejected indication information indicating that the QoE measurement is rejected. In some other embodiments of the present application, the RAN node is an SN and a peer node is an MN, and the processor is configured to: transmit, to the MN, QoE configuration request information to request whether a QoE measurement is allowed; and receive the first information from the MN, wherein the first information is QoE configuration allowed indication information indicating that the QoE measurement is allowed or QoE configuration rejected indication information indicating that the QoE measurement is rejected.

According to some embodiments of the present application, a RRC identifier of the configuration of the QoE measurement is allocated by the MN and transmitted to the SN with the QoE configuration allowed indication information, or is allocated by the SN and transmitted to the MN with the QoE configuration request information. In some scenarios, the RRC identifier of the configuration of the QoE measurement is determined as the third information to be used for corresponding RVQoE measurement by MN and SN.

According to some embodiments of the present application, the QoE configuration rejected indication information indicates a RRC identifier of corresponding configuration information of the QoE measurement allocated by the MN. In some scenarios, the RRC identifier is determined as the third information to be used for corresponding RVQoE measurement by the SN.

According to some embodiments of the present application, the QoE configuration rejected indication information indicates a cause value to indicate why the QoE configuration is rejected.

According to some embodiments of the present application, the QoE configuration request information includes at least one of QoE reference, area scope or service type of the QoE measurement.

In some embodiments of the present application, the processor is configured to: transmit the first information to a peer node, wherein the first information is QoE measurement configuration indication information indicating that a QoE measurement has already been or will be configured to a UE by the RAN node. In some other embodiments of the present application, the processor is configured to: receive the first information from a peer node, wherein the first information is QoE measurement configuration indication information indicating a QE measurement has already been or will be configured to a UE by the RAN node.

According to some embodiments of the present application, the QoE measurement configuration indication information indicates a RRC identifier of corresponding QoE configuration of the QoE measurement allocated by the MN. In some scenarios, the RRC identifier is determined as the third information to be used for corresponding RVQoE measurement by the RAN node and peer node.

In some embodiments of the present application, the processor is configured to: transmit to a peer node, a QoE configuration subscription request to subscribe QoE measurements configured by the peer node; and receive the first information from the peer node, wherein the first information is QoE configuration addition indication information indicating QoE measurements configured to a UE or QoE configuration released indication information indicating released QoE measurements to a UE. In some other embodiments of the present application, the processor is configured to: receive from a peer node, a QoE configuration subscription request to subscribe QoE measurements configured by the peer node; and transmit the first information to the peer node, wherein the first information is QoE configuration addition indication information in response to configuring a QoE measurement to a UE, or QoE configuration release indication information in response to releasing the QoE measurement configured to a UE.

According to some embodiments of the present application, in the case that the QoE configuration subscription request indicates at least one QoE reference, only addition or release of the QoE measurements associated with the at least one QoE reference are reported; and in the case that no QoE reference is indicated in the QoE configuration subscription request, addition or release of any QoE measurement is reported.

In some embodiments of the present application, the RAN node is an MN and a peer node is an SN, and the processor is configured to: transmit the second information to the SN, wherein the second information indicates a RRC identifier value range for QoE measurements used by the SN. In some scenarios, the second information indicating a RRC identifier value range for QoE measurements used by the SN is transmitted in response to a request from the SN. In some other embodiments of the present application, the RAN node is an SN and a peer node is an MN, and the processor is configured to: receive the second information from the MN, wherein the second information indicates a RRC identifier value range for QoE measurements used by the SN. In some scenarios, the processor is configured to: transmit a request of requesting the RRC identifier value range to the MN.

According to some embodiments of the present application, the RRC identifier value range is determined by the SN as the third information to be used for RVQoE measurements by the SN.

In some embodiments of the present application, the RAN node is an MN and a peer node is an SN, and the processor is configured to: receive a request of requesting a RRC identifier for a QoE measurement from the SN; and transmit the second information to the SN, wherein the second information indicates the RRC identifier for the QoE measurement. In some other embodiments of the present application, the RAN node is an SN and a peer node is an MN, and the processor is configured to: transmit a request of requesting a RRC identifier for a QoE measurement to MN; and receive the second information from the MN, wherein the second indicates the RRC identifier for the QoE measurement.

According to some embodiments of the present application, the request includes at least one of QoE reference or service type of the QoE measurement.

According to some embodiments of the present application, the RRC identifier is determined by the SN as the third information to be used for corresponding RVQoE measurement by the SN.

In some embodiments of the present application, the processor is configured to transmit the second information to a UE, and in the case that the RAN node is an MN, the second formation indicates measConfigAppLayerId and an MN index for a QoE measurement configured by the MN to the UE; and in the case that the RAN node is an SN, the second formation indicates measConfigAppLayerId and an SN index for a QoE measurement configured by the SN to the UE.

In some embodiments of the present application, the RAN node is an MN and a peer node is an SN, and the processor is configured to: transmit the third information to the SN, wherein the third information indicates a RRC identifier value range for RVQoE measurements used by the SN.

According to some embodiments of the present application, the third information indicating a RRC identifier value range for RVQoE measurements used by the SN is transmitted in response to a request from the SN.

In some embodiments of the present application, the RAN node is an SN and a peer node is an MN, and the processor is configured to: receive the third information from the MN, and the third information indicates a RRC identifier value range for RVQoE measurements used by the SN.

According to some embodiments of the present application, the processor is configured to: transmit a request to request the RRC identifier value range for RVQUE measurements used by the SN.

In some embodiments of the present application, the RAN node is an MN and a peer node is an SN, and the processor is configured to: receive from the SN, a request of requesting a RRC identifier for a RVQoE measurement; and transmit the third information to the SN, wherein the third information indicates the RRC identifier for the RVQoE measurement. In some other embodiments of the present application, the RAN node is an SN and a peer node is an MN, and the processor is configured to: transmit a request of requesting a RRC identifier for a RVQoE measurement to the MN; and receive the third information from the MN, and the third information indicates the RRC identifier for the RVQoE measurement.

According to some embodiments of the present application, the RRC identifier for the RVQoE measurement is only used by the SN or is shared by both the SN and MN.

In some embodiments of the present application, the processor is configured to transmit the third information to a UE, in the case that the RAN node is an MN, the third information indicates measConfigAppLayerId and an MN index for a RVQoE measurement configured by the MN to the UE; and in the case that the RAN node is an SN, the third information indicates measConfigAppLayerId and an SN index for a RVQoE measurement configured by the SN to the UE.

In some embodiments of the present application, in the case that duplication indication information indicating that QoE configuration information from the RAN node is ignored due to being duplicated with other QoE configuration information for a same QoE measurement is received from a UE, the processor is configured to determine a RRC identifier of other QoE configuration information received with the duplication indication information as the third information to be used for corresponding RVQoE measurement by the RAN node.

Some yet other embodiments of the present application provide a method of supporting QoE measurement collection, e.g., performed by a UE, which includes: receiving first QoE configuration information from a first RAN node; receiving second QoE configuration information from a second RAN node; and transmitting duplication indication information to at least one of the first RAN node or the second RAN node in response to that the first QoE configuration information and the second QoE configuration information are associated with a same QoE measurement, wherein, the duplication indication information indicates that at least one of the first QoE configuration information or the second QoE configuration information is ignored due to the first QoE configuration information and the second QoE configuration information being duplicated for a QoE measurement.

Some yet other embodiments of the present application provide a method of supporting QoE measurement collection, which may be performed in a RAN node, e.g., a MN or SN, and the method includes: receiving information indicating at least one QoE measurement; and determining information associated with configurations of the at least one QoE measurement, wherein the information associated with configurations of the at least one QoE measurement includes at least one of: first information related to whether a same QoE measurement is configured to a UE by an MN or an SN, second information related to RRC identifiers for QoE measurements, or third information related to RRC identifiers for RVQoE measurements.

Given the above, embodiments of the present application provide a method and apparatus of supporting QoE measurement collection, which can coordinate QoE measurements (including RVQoE measurements in some scenarios) by MNs and SNs in NR-DC scenarios. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 is a flow chart of a procedure of QoE measurement collection in Scenario 1 according to some embodiments of the present application.

FIG. 3 is a flow chart of a procedure of QoE measurement collection in Scenario 2 according to some embodiments of the present application.

FIG. 4 is a flow chart of a procedure of QoE measurement collection in Scenario 3 according to some embodiments of the present application.

FIG. 5 is a flow chart of a procedure of QoE measurement collection in Scenario 4 according to some embodiments of the present application.

FIG. 6 illustrates a block diagram of an apparatus of supporting QoE measurement collection according to some embodiments of the present application.

FIG. 7 illustrates a block diagram of an apparatus of supporting QoE measurement reporting according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems. Moreover, the terminologies recited in the present application may change, which should not affect the principle of the present application.

In a NR-DC scenario, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as an MN and the other node may act as an SN. The MN and SN are connected via a network interface, e.g., Xn interface as specified in 3GPP standard documents, and at least the MN is connected to the core network (CN).

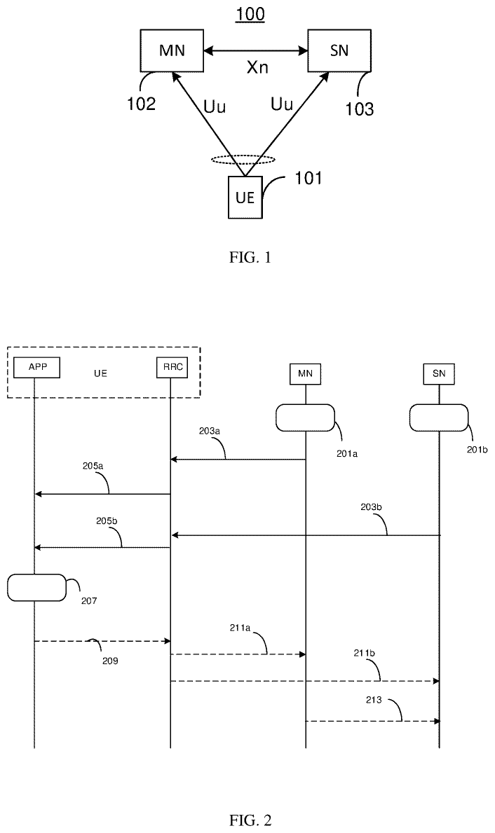

For example, FIG. 1 illustrates a schematic diagram of a wireless communication system 100 in accordance with some embodiments of the present application.

As shown in FIG. 1, the wireless communication system 100 may be a dual connectivity system 100 includes at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, the UE 101 may connect to the MN 102 and the SN 103 via an interface, for example, Uu interface as specified in 3GPP standard documents. The MN 102 and the SN 103 may be connected with each other via a network interface, for example, Xn interface as specified in 3GPP standard documents. The MN 102 may be connected to the core network via a network interface (not shown in FIG. 1), for example, NG interface as specified in 3GPP standard documents. The UE 101 may be configured to utilize resources provided by the MN 102 and the SN 103 to perform data transmission.

In some embodiments of the present application, the UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE 101 may include wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The MN 102 refers to a radio access network (RAN) node that provides a control plane connection to the core network. In an embodiment of the present application, in the E-UTRA-NR DC (EN-DC) scenario, the MN 102 may be an eNB. In another embodiment of the present application, in the next generation E-UTRA-NR DC (NGEN-DC) scenario, the MN 102 may be a next generation (ng)-eNB. In yet another embodiment of the present application, in the NR-DC scenario or the NR-E-UTRA DC (NE-DC) scenario, the MN 102 may be a gNB. An MN 102 may also be referred to as a master-NG-RAN (M-NG-RAN) node in some embodiments of the present application.

An MN leg may be referred to as an MCG. The MCG may refer to a group of serving cells associated with the MN 102, and include a primary cell (PCell) and optionally one or more secondary cells (SCells). The PCell may provide a control plane connection to the UE 101.

The SN 103 may refer to a radio access network node without control plane connection to the core network but providing additional resources to the UE 101. In some embodiments of the present application, in the EN-DC scenario, the SN 103 may be an en-gNB. In some other embodiments of the present application, in the NR-DC scenario, the SN 103 may be a ng-eNB. In yet another embodiment of the present application, in the NR-DC scenario or the NGEN-DC scenario, the SN 103 may be a gNB. A SN 103 may also be referred to as a secondary-NG-RAN (S-NG-RAN) node in some embodiments of the present application.

A SN leg may be referred to as an SCG. The SCG may refer to a group of serving cells associated with the SN, and include a primary secondary cell (PSCell) and optionally one or more SCells.

The PCell of the MCG and the PSCell of the SCG may also be referred to as a special cell (SpCell).

In addition, regarding QoE measurement collection (QMC, also referred to as “QoE measurement”) activation and reporting, TS38. 300 specifies the following:
“The feature is activated in the NG-RAN either by direct configuration from the OAM system (management-based activation), or by signalling from the OAM via the Core Network (signalling-based activation), containing UE-associated QoE configuration. One or more QoE measurement collection jobs can be activated at a UE per service type, and each QoE measurement configuration is uniquely identified by a QoE Reference.
For signalling-based QoE measurements, the OAM initiates the QoE measurement activation for a specific UE via the Core Network, and the NG-RAN node receives one or more QoE measurement configurations by means of UE-associated signalling. The QoE measurement configuration for signalling-based activation includes an application layer measurement configuration list and the corresponding information for QoE measurement collection, e.g., QoE Reference, service type, MCE IP Address, Slice Scope, Area Scope, MDT Alignment Information and the indication of available RAN visible QoE metrics. Each application layer measurement configuration is encapsulated in a transparent container. The NG-RAN node forwards the corresponding QoE measurement configuration(s) to the UE in a downlink RRC message containing AppLayerMeasConfig, as specified in TS38.331 [12].
For management-based QoE measurement activation, the OAM sends one or more the QoE measurement configurations to the NG-RAN node. The QoE measurement configuration for management-based activation also includes an application layer measurement configuration list and the corresponding information for QoE measurement collection. Each application layer measurement configuration is encapsulated in a transparent container. The NG-RAN node selects UE(s) that meet the required QoE measurement capability, Area Scope and Slice Scope.
The UE reports QoE measurement results to the NG-RAN node in an uplink RRC message, as specified in TS38.331[12]. The NG-RAN node transmits the QoE report and the corresponding QoE Reference ID to the MCE.
The QoE measurement collection is handled by application layer measurement configuration and measurement reporting, supported in RRC_CONNECTED state only. Application layer measurement configuration received by the gNB from OAM or CN is encapsulated in a transparent container, which is forwarded to a UE as Application layer configuration in the RRCReconfiguration message (there can be multiple configurations in the same message). Application layer measurement reports received from UE's higher layer are encapsulated in a transparent container and sent to the network in the MeasurementReportAppLayer message, as specified in TS 38.331 [12 ]. The UE can send multiple application layer measurement reports to the gNB in one MeasurementReportAppLayer message. In order to allow the transmission of application layer measurement reports which exceed the maximum PDCP SDU size, segmentation of the MeasurementReportAppLayer message may be enabled by the gNB. A measConfigAppLayerId conveyed in the RRC signalling is used to identify the application layer measurement configuration and report between the gNB and the UE. The RRC identifier is mapped to the QoE Reference in the gNB. The application layer measurement report is forwarded to OAM together with the QoE Reference. gNB can release one or multiple application layer measurement configurations from the UE in one RRCReconfiguration message at any time. The UE may additionally be configured by the gNB to report when a QoE measurement session starts or stops for a certain application layer measurement configuration.”

Thus, QoE measurement collection in the NG-RAN can be activated by two manners, i.e., management-based activation and signalling-based activation. In the case of management-based activation, the RAN node, e.g., a gNB receives direct configuration from the OAM (or OAM system). In the case of signalling-based activation, the RAN node receives signalling containing UE-associated QoE configuration from the OAM via the CN. The application layer measurement configuration received by the gNB from the OAM or CN is encapsulated in a transparent container in Rel-17, which is forwarded to a UE as application layer configuration in a RRCReconfiguration message (there can be multiple configurations in the same message). Application layer measurement reports received from UE's application layer are encapsulated in a transparent container and sent to the network in a MeasurementReportAppLayer message. In order to allow the transmission of application layer measurement reports which exceed the maximum PDCP SDU size, segmentation of the MeasurementReportAppLayer message may be enabled by the gNB.

According to RP-213159, the support for QoE measurement configuration and measurement reporting over MN/SN for NR-DC scenario will be settled in Rel-18, and thus a mass of issues need to be solved. Taking management-based QoE measurements as an example, since both the MN and SN may receive QoE measurement configurations from the OAM, some problems may happen in the case of no co-ordination between the MN and SN.

In an exemplary scenario, the OAM may provide the same QoE measurement configuration to both the MN and SN separately because the OAM is not aware whether NR-DC is configured for a UE or not. In the case of lacking coordination between the MN and SN, both the MN and SN may provide the QoE measurement with different allocated measConfigAppLayerIds to the same UE respectively (issue 1). Accordingly, the application layer of the UE may receive two same application layer measurement configurations with different mesConfigAppLayerIds from the MN and SN respectively, which may cause QoE measurement failure in the application layer of the UE. Even in the case that the measConfigAppLayerIds allocated by MN and SN are the same for the same QoE measurement, there will be issues due to the two duplicated QoE measurements.

In another exemplary scenario, although the OAM provides different QoE measurement configurations to both the MN and SN separately, the MN and SN may respectively allocate the same measConfigAppLayerId to the different QoE measurements to the same UE due to no coordination between the MN and SN (issue 2). Accordingly, the RRC layer of the UE may receive two QoE measurements with the same mesConfigAppLayerId and forward them to the application layer of the UE. However, the application layer of the UE is unclear on how to handle the two application measurement configurations, e.g., whether the first received application measurement configuration with the mesConfigAppLayerId should be replaced by the later one with the same mesConfigAppLayerId or not.

In addition, in the case that RVQoE measurements whose measurement results are visible for RAN node are considered, how to coordinate RVQE configuration and reporting between the MN and SN should also be solved (issue 3). Regarding a RVQoE measurement (or RVQoE configuration), it is configured by a gNB, where a subset of QoE metrics are reported from the UE as an explicit IE readable by the gNB. The RVQoE measurement can be utilized by the gNB for network optimization. Each RVQoE measurement configuration and report is identified by the same RRC identifier as the application layer measurement configuration and measurement report (regular QoE measurement). The RVQUE measurements can be reported with a reporting periodicity different from the one of regular QoE measurements. If there is no reporting periodicity defined in the RAN visible QoE configuration, RAN visible QoE reports are sent together with the regular QoE reports. Without coordination between MN and SN, the MN or SN may not know the RRC identifier of the regular QoE measurement for RVQoE configuration in the case that the RRC identifier has been allocated for regular QoE measurement by peer node already.

At least to solve the above issues on QoE measurements, embodiments of the present application provide technical solutions of supporting QoE measurement collection (even RVQOE measurements being configured), e.g., a method and apparatus of supporting QoE measurement collection considering coordination between the MN and SN.

For example, some embodiments of the present application provide a method of supporting QoE measurement collection, which can be performed by a UE or the like. The method includes: receiving, e.g., by the RRC layer of the UE, first QoE configuration information from a first RAN node (e.g., an MN); receiving, e.g., by the RRC layer of the UE, second QoE configuration information from a second RAN node (e.g., an SN); and transmitting duplication indication information to at least one of the first RAN node or the second RAN node in response to that the first QoE configuration information and the second QoE configuration information are associated with the same QoE measurement (e.g., the application layer measurement configuration of the two QoE configuration information are the same). Exemplary duplication indication information will indicate that one of the first and second QoE configuration information is ignored (or rejected or cancelled) due to the first and second QoE configuration information being duplicated for a QoE measurement, and indicates a RRC identifier of the ignored QoE configuration information. Another exemplary duplication indication information will indicate that both the first and second QoE configuration information are ignored (or rejected or cancelled) due to being duplicated for a QoE measurement, and indicates a RRC identifier of each ignored QoE configuration information.

Some other embodiments of the present application provide another method of supporting QoE measurement collection, which may be performed in a RAN node, e.g., a MN or SN or the like. The method includes: receiving information indicating at least one QoE measurement (e.g., from the CN or OAM by the MN, or from the OAM or MN by the SN); and determining information associated with configurations of the at least one QoE measurement, wherein the information associated with configurations of the at least one QoE measurement includes at least one of: information related to whether the same QoE measurement is configured to a UE by the MN or the SN, information related to RRC identifiers for QoE measurements, or information related to RRC identifiers for RVQoE measurements.

The information related to whether the same QoE measurement is configured to a UE by an MN or an SN (hereafter, first information) can coordinate QoE configuration and reporting between two RAN nodes, e.g., the MN and SN to avoid the same QoE measurement, e.g., the same management-based QoE measurement being configured to the same UE by both the MN and SN. Exemplary first information is QoE configuration allowed indication information indicating that the QoE measurement from the SN is allowed by the MN, or QoE configuration rejected indication information indicating that the QoE measurement from the SN is rejected by the MN, or other related information. The information related to RRC identifiers for QoE measurements (hereafter, second information) can coordinate QoE configuration and reporting between two RAN nodes, e.g., the MN and SN to avoid two different QoE measurements, e.g., two different management-based QoE measurements with the same RRC identifier being configured to the same UE. Exemplary second information is a RRC identifier value range, or a specific RRC identifier value for QoE measurement(s) used by the MN or SN, or other related information. The information related to RRC identifiers for RVQoE measurements (hereafter, the third information) can coordinate RVQoE configuration and reporting between two RAN nodes, e.g., the MN and SN to avoid issues similar to those solved by the first information and second information. Exemplary third information is a RRC identifier value range, or a single RRC identifier value for RVQUE measurement(s) used by the MN and/or SN, or other related information. The first information, second information and third information can be applied in embodiments of the present application alone or in any combination to solve partial or all of issues 1 to 3. That is, an embodiment of the present application may apply all the first information, second information and third information, or apply two of the first information, second information and third information, or apply only one of the first, second and third information. In some embodiments of the present application, the second and/or third information may be implied in the first information.

Some detailed embodiments of the present application will be illustrated hereafter in view of some exemplary NR-DC scenarios. Persons skilled in the art should understand that although MNs and SNs in NR-DC are illustrated in the exemplary embodiments, the illustrated technical solution may also be applied to similar RAN nodes and/or similar scenarios and should not be limited to specific apparatuses and scenarios. In addition, although different exemplary embodiments are illustrated focusing on different technical measures for clearness, they can be combined in various manners by persons skilled in the art under the disclosure and teaching of the present application while not specifically illustrated.

Firstly, some embodiments of the present application mainly considering issue 1 are illustrated in the following.

According to some embodiments of the present application (Scenario 1), the UE will determine whether two QoE measurement configurations (or configuration information) from the MN and SN are duplicated and ignore (or reject or cancel or the like) one or both of the duplicated QoE measurement configurations. FIG. 2 is a flow chart of a procedure of QoE measurement collection under Scenario 1 according to some embodiments of the present application.

Referring to FIG. 2, in step 201a, a RAN node served as an MN may receive information indicating at least one QoE measurement. For example, the MN may receive QoE measurement activation information, which is either direct configuration(s) from the OAM (e.g., in the case of management-based QoE measurement), or signalling from the OAM via the CN containing UE-associated QoE configuration (e.g., in the case of signalling-based QoE measurement). For management-based QoE measurements, the OAM will send one or more QoE measurement configurations to the RAN node. For signalling-based QoE measurements, the OAM will initiate the QoE measurement activation for a specific UE via the CN node, and the CN node will send QoE measurement configuration information to the RAN node for QoE measurement activation. Exemplary QoE measurement configuration information from CN or OAM (also referred to as “CN/OAM QoE measurement configuration information”) includes:
QoE Reference: which is used to identify a QoE measurement between gNB and CN or between gNB and OAM;
Service Type: which indicates the service type of QoE measurements;
Container for Application Layer Measurement Configuration: which contains application layer measurement configuration; and
Area Scope: the area scope of the QoE measurement, which includes a list of cells, tracking area (TA), tracking area ID (TAI), or public land mobile network (PLMN).

Similarly, in step 201b, another RAN node served as an SN may also receive information indicating at least one QoE measurement. For example, the SN may receive QoE measurement activation information from the MN (in the case of signaling-based QoE measurement) or QoE measurement configuration information from the OAM (in the case of management-based QoE measurement). For management-based QoE measurements, the SN may receive the QoE measurement configuration from the OAM as the above illustrated in view of MN, wherein the received QoE measurement configuration may be different from that to the MN or identical with that to the MN. For signaling-based QoE measurements, the MN will receive the QoE measurement activation signalling from the OAM via the CN, and then request the SN to provide QoE measurement configuration to the UE by transmitting the QoE measurement activation information, e.g., in an S-Node Addition Request message or S-Node Modification Request message or the like. The MN may also include the UE QoE measurement capability in the message. Exemplary QoE measurement activation information may include QoE reference, service type, measurement collection entity (MCE) internet protocol (IP) address, slice scope, area scope, or minimization of drive tests (MDT), alignment information and the indication of available RVQoE metrics etc. In some embodiments of the present application The MN may also send requested signalling radio bearer (SRB) type, e.g., SRB3 for the requested QoE measurement to the SN.

Herein, only management-based QoE measurements will be illustrated in Scenario 1 as an example to illustrate how to solve issues caused by duplicated QoE measurement configurations from the MN and SN. It is assumed that the MN and SN receive the same QoE measurement, e.g., with QoE reference being 1, and both the MN and SN select the same UE with DC configuration for the management-based QoE measurement. However, persons skilled in the art should well know that the illustrated technical solution can also be applied to signaling-based QoE measurement.

Specifically, the MN will select a UE that meet the required QoE measurement after receiving a QoE measurement, and allocate (or assign or configure etc.) a RRC identifier (hereafter, MN RRC identifier), e.g., measConfigAppLayerId being 2 to the QoE measurement, which is used to identify the QoE configuration of the QoE measurement between the MN and the UE, e.g., an application layer measurement configuration (also referred to as a RRC QoE measurement configuration) of the QoE measurement between the MN and the UE. Hereafter, the QoE configuration of the QoE measurement between the MN and the UE identified by a RRC identifier is also referred to as an MN QoE configuration. Exemplary MN QoE configuration includes the MN RRC identifier and application layer measurement container of the QoE measurement. In step 203a, the MN will transmit the MN QoE configuration to the selected UE, e.g., by a RRC signaling (e.g., in AppLayerMeasConfig in a RRCReconfiguration message).

Similarly, the SN will select the same UE as a UE that meet the required QoE measurement after receiving the QoE measurement with QoE reference being 1, while independent allocate another RRC identifier (hereafter, SN RRC identifier), which is identical or different from the MN identifier, e.g., measConfigAppLayerId being 3 to the same QoE measurement. Hereafter, the QoE configuration of the QoE measurement between the SN and the UE identified by a RRC identifier is also referred to as an SN QoE configuration. In step 203b, the SN will transmit the SN QoE configuration of the QoE measurement to the selected UE, e.g., by a RRC signaling, e.g., by SRB3. Exemplary SN QoE configuration of the QoE measurement includes the SN RRC identifier and application layer measurement container of the QoE measurement.

From the perspective of the UE, it may receive QoE measurement configurations from both the MN and SN, e.g., two application layer QoE configurations respectively from the MN and SN (each corresponding to an MCG or SCG leg). According to some embodiments of the present application, the UE will determine (or detect, or identify etc.) whether the QoE configuration from the MN and that from the SN are associated with the same QoE measurement, that is, whether the QoE configuration from the MN and that from the SN are duplicated. If there are two duplicated QoE configurations, the UE will ignore at least one of the two duplicated QoE configurations. When only one QoE configuration is ignored, which one of the duplicated QoE configurations will be ignored can be made based on various standards, e.g., the time of the QoE configuration arriving at the application layer of the UE etc.

Specifically, in exemplary embodiments illustrated in FIG. 2, the RRC layer of the UE will receive the MN QoE configuration from the MN in step 203a and receive the SN QoE configuration from the SN in step 203b, and then forward the MN QoE configuration and the SN QoE configuration respectively to the application layer of the UE in steps 205a and 205b. For the received MN QoE configuration and SN QoE configuration, the application layer will perform a QoE measurement duplication detection (or determination or the like) in step 207 to detect whether the MN QoE configuration and SN QoE configuration are duplicated, e.g., by decoding the application layer measurement container in each QoE configuration. In the case that the application layer identifies that the two received application layer measurement containers are for the same QoE measurement, the application layer will make a decision that the two QoE configurations respectively from the MN and SN are duplicated. In response to the decision of being duplicated, the application layer will ignore one or both of the two duplicated QoE configurations. For example, the application layer may ignore the later received one and perform the QoE measurement according to the first received QoE measurement configuration.

The UE will generate duplication indication information (or QoE configuration duplication indication etc.), e.g., by the application layer and transmit it to the network side. The QoE configuration duplication indication indicates that QoE configurations from the MN and SN are duplicated. The QoE configuration duplication indication also indicates that one or both of the duplicated QoE configurations are ignored, and including the corresponding RRC identifier(s) to identify the ignored QoE configuration(s).

Specifically, in exemplary embodiments illustrated in FIG. 2, the application layer of the UE will send QoE configuration duplication indication to the RRC layer of the UE in step 209. For example, if the SN QoE configuration is ignored, the application layer of the UE will provide the SN RRC identifier, e.g., 3 in the QoE configuration duplication indication, so that the RRC layer of the UE knows that the QoE configuration provided by the SN is ignored based the RRC identifier being 3. if the MN QoE configuration is ignored, the application layer of the UE will provide the MN RRC identifier, e.g., 2 in the QoE configuration duplication indication, so that the RRC layer of the UE knows that the QoE configuration provided by the MN is ignored based the RRC identifier being 2. Then, the RRC layer of the UE will send the QoE configuration duplication indication to the network side.

In some embodiments of the present application, the QoE configuration duplication indication will be transmitted to the RAN node(s) associated with the ignored QoE configuration(s). For example, in the case that the MN QoE configuration is ignored, the RRC layer of the UE will transmit the QoE configuration duplication indication with the MN RRC identifier to the MN in step 211a, e.g., by SRB1, so that the MN knows that the MN QoE configuration is ignored by the UE due to being duplicated. If the SN QoE configuration is ignored, the RRC layer of the UE will send the QoE configuration duplication indication with the SN RRC identifier to the SN in step 211b, e.g., by SRB3, so that the SN knows the SN QoE configuration is ignored by the UE due to being duplicated. In the case that both of the two duplicated QoE configurations are ignored, the QoE configuration duplication indication will be transmitted to the MN and SN respectively. Both of the MN RRC identifier and SN RRC identifier may be included in each QoE configuration duplication indication to the MN and SN, that is, the QoE configuration duplication indication to the MN and SN is identical. In some other embodiments of the present application, the MN RRC identifier will only be indicated in QoE configuration duplication indication to the MN and the SN RRC identifier will only be indicated in QoE configuration duplication indication to the SN, that is, the QoE configuration duplication indication to the MN and SN is independent from each other, which is similar to operations in the case of only one QoE configuration being ignored.

In some other embodiments of the present application, the UE will transmit the QoE configuration duplication indication only to the MN regardless of which QoE configuration(s) being ignored. If the SN QoE configuration is ignored (either in the case of only one QoE configuration being ignored or in the case of both two being ignored), the MN will transfer the received QoE configuration duplication indication to the SN in step 213. In the case that the MN receives the QoE configuration duplication indication with the MN RRC identifier and SN RRC identifier, the MN may directly transfer the QoE configuration duplication indication to the SN or transmit a QoE configuration duplication indication with only the SN RRC identifier to the SN.

According to some yet other embodiments of the present application, in the case that only one of the MN QoE configuration and SN QoE configuration is ignored, the QoE configuration duplication indication may also indicate the RRC identifier allocated for the QoE configuration that is not ignored. For example, in the case that the SN QoE configuration is ignored, the QoE configuration duplication indication to the SN will also indicate the MN RRC identifier, so that the SN may use the MN RRC identifier for RVQoE measurement. That is, the RRC identifier allocated by a RAN node for the QoE configuration that is not ignored can be transmitted to the peer RAN node of the RAN node whose QoE configuration is ignored, and the peer RAN node can determine the RRC identifier allocated by the RAN node as the third information, e.g., RVQoE RRC identifier, and use it when configuring corresponding RVQoE measurement. Accordingly, the solutions illustrated in view of Scenario 1 can solve also the issues on RRC identifier for RVQoE measurement.

According to some embodiments of the present application (Scenario 2), after receiving the information indicating at least one QoE measurement, the RAN node served as an SN will transmit a request, e.g., QoE configuration request information to another RAN node served as MN to request whether the indicated QoE measurement is allowed to avoid the same QoE measurement being repeatedly configured to the UE by the MN and SN. If the QoE measurement is not allowed, the SN will not transmit the QoE measurement to the UE. FIG. 3 is a flow chart of a procedure of QoE measurement collection under Scenario 2 according to some embodiments of the present application.

Referring to FIG. 3, in step 301, a RAN node served as an SN may receive information indicating at least one QoE measurement, which is identical with that illustrated in FIG. 2 and will not repeat herein. Regarding a RAN node served as an MN, it may also receive information indicating at least one QoE measurement as illustrated in FIG. 2, or not.

Similarly, only management-based QoE measurements will be illustrated in Scenario 2 as an example to illustrate how to solve issues caused by duplicated QoE measurement configurations from the MN and SN. However, persons skilled in the art should well know that the illustrated technical solution can also be applied to signaling-based QoE measurement.

The SN will select a UE that meet the required QoE measurement. In step 303, the SN will transmit QoE configuration request information to the MN to request the MN whether the QoE measurement is allowed or not. On or more QoE measurements can be included in the same request. Exemplary QoE configuration request information includes at least one of the QoE reference associated with a QoE measurement, area scope or service type. In some embodiments of the present application, the QoE configuration request information may further include an SN RRC identifier allocated (or configured) by the SN. The QoE configuration request information may be carried in an S-NG-RAN Node Modification Required message or the like.

After receiving the QoE configuration request information, the MN will decide whether the requested QoE measurement is allowed (e.g., including: whether the requested QoE measurement can be configured by the SN, or whether configuration of the QoE measurement is allowed), and then transmit a response (first information) to the SN indicating whether the requested QoE measurement is allowed or rejected in step 305, e.g., via an S-NG-RAN node Modification Confirm message or the like.

In some cases, the MN may decide that the QoE measurement requested by the SN is allowed. For example, if the MN QoE configuration has not been configured to the UE or will not be configured to the UE by the MN, the MN may send QoE configuration allowed indication information to the SN. Exemplary QoE configuration allowed indication information includes a QoE reference to indicate which QoE measurement is allowed by the MN. The QoE configuration allowed indication information may be included in an S-NG-RAN node Modification Confirm message or the like.

After receiving the QoE configuration allowed indication information, the SN will provide an SN QoE configuration of the QoE measurement to the UE in step 207. In some embodiments of the present application, before transmitting the QoE configuration request information, the SN has not configured the SN QoE configuration for the QoE measurement yet. After receiving the QoE configuration allowed indication information, the SN will firstly configure an SN QoE configuration of the QoE measurement and then transmit it to the UE.

In some other cases, the MN may decide to reject the requested QoE measurement. For example, if the MN QoE configuration of the QoE measurement has been already configured to the UE or will be configured to the UE by the MN, the MN may decide that the requested QoE measurement is not allowed. For another example, if the MN is not in the area scope provided in the QoE configuration request information, the MN will reject the QoE measurement. In response to the decision that the QoE measurement is not allowed or is rejected, the MN may send QoE configuration rejected indication information to the SN to indicate that the requested QoE measurement is not allowed. The MN may also provide a cause value in the QoE configuration rejected indication information to indicate why the QoE measurement is rejected or not allowed, e.g., due to that the QoE measurement has been configured to the UE already by the MN, or will be configured to the UE by the MN, or due to that the MN is not within the area scope.

Solutions illustrated in view of Scenario 2 can also solve the issues on RRC identifier for RVQoE measurement. For example, in some embodiments of the present application, in the case that the SN RRC identifier is included in the QoE configuration request information and the requested QoE measurement is allowed, the MN may also store the SN RRC identifier and use it as the third information (e.g., RRC identifier for RVQoE measurement) for corresponding RVQoE measurement if necessary. In the case that the requested QoE measurement is not allowed, the MN may also indicate the MN RRC identifier of the QoE measurement to the SN. The SN may use the allocated RRC identifier by the MN as the third information for corresponding RVQoE configuration if necessary.

Compared with Scenario 1, descriptions on Scenario 2 are simplified to avoid unnecessary duplication. Persons skilled in the art should well know that some similar or identical details illustrated in Scenario 1 can also be applied to Scenario 2 in the same or similar way.

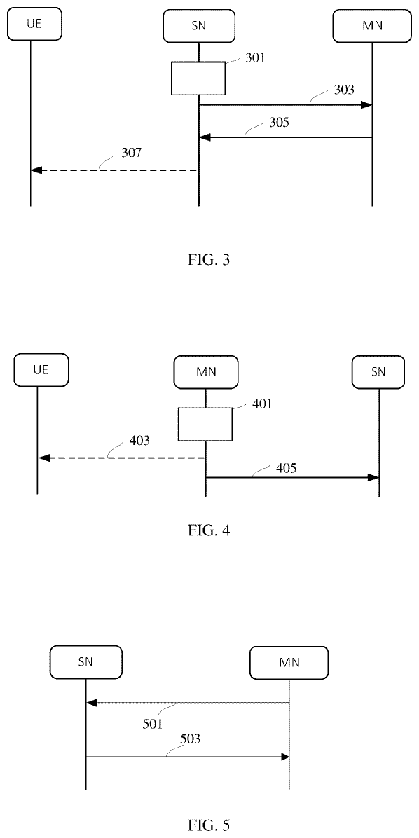

According to some embodiments of the present application (Scenario 3), after receiving the information indicating at least one QoE measurement, e.g., an M-based QoE measurement and selecting a UE with DC configuration, a RAN node served as an MN or an SN will send QoE measurement configuration indication information to a peer RAN node served as an SN or an MN, which indicates that a QoE measurement has already been or will be configured to a UE by the RAN node to avoid the same QoE measurement being repeatedly configured to the UE by the peer RAN node. FIG. 4 is a flow chart of a procedure of QoE measurement collection under Scenario 3 according to some embodiments of the present application. Although in the embodiments illustrated in FIG. 4, the RAN node is an MN and the peer RAN node is an SN, persons skilled in the art should well know that how to apply similar solutions in the case that the RAN node is an SN and the peer RAN node is an MN.

Referring to FIG. 4, in step 401, an MN may receive information indicating at least one QoE measurement, which is identical with that illustrated in FIG. 2 regarding a RAN node served as an MN, and will not repeat herein.

Similarly, only management-based QoE measurements will be illustrated in Scenario 3 as an example to illustrate how to solve issues caused by duplicated QoE measurement configurations from the MN and SN. However, persons skilled in the art should well know that the illustrated technical solution can also be applied to signaling-based QoE measurement.

The MN will select a UE that meet the required QoE measurement. In step 403, the MN may configure the QoE measurement and transmit it to the UE. The MN will transmit QoE configuration indication information (first information) to the SN in step 405, indicating that the QoE measurement has already been or will be configured to the UE by the MN. In some embodiments of the present application, the MN may transmit the QoE configuration indication information before transmitting the QoE measurement to the UE. The QoE configuration indication information may be carried in an S-NG-RAN Node Addition request message or S-NG-RAN Node Modification Request message or the like. Exemplary QoE measurement configuration indication information includes the QoE reference of the QoE measurement.

After receiving the QoE measurement configuration indication information, the SN will be aware of the M-based QoE measurement which has been configured to the UE by the MN or to be configured to the UE by the MN. The SN will not trigger the same M-based QoE measurement (if received) to the UE, and accordingly no duplicated QoE measurement will be transmitted to the UE.

Solutions illustrated in view of Scenario 3 can also solve the issues on RRC identifier for RVQoE measurement. For example, in some embodiments of the present application, a RAN node, e.g., the MN may also include the RRC identifier of the QoE measurement allocated by the RAN node in the QoE measurement configuration indication information, so that the peer RAN node can at least use the allocated MN RRC identifier as the third information for corresponding RVQoE measurement if necessary.

Similarly, compared with Scenario 1, descriptions on Scenario 3 are simplified to avoid unnecessary duplication. Persons skilled in the art should well know that some similar or identical details, specifically the information indicating the QoE measurement illustrated in Scenario 1 can also be applied to Scenario 3 in the same or similar way.

According to some embodiments of the present application (Scenario 4), a RAN node served as an MN or an SN will send a QoE configuration subscription request to a peer RAN node served as an SN or an MN, to subscribe QoE measurements configured by the peer node. FIG. 5 is a flow chart of a procedure of QoE measurement collection under Scenario 4 according to some embodiments of the present application. Although in the embodiments illustrated in FIG. 5, the RAN node is an MN and the peer RAN node is an SN, persons skilled in the art should well know that how to apply similar solutions in the case that the RAN node is an SN and the peer RAN node is an MN.

Referring to FIG. 5, in step 501, an MN will transmit a QoE configuration subscription request to an SN to subscribe QoE measurements configured by the SN. An exemplary QoE configuration subscription request may indicate at least one QoE reference, e.g., QoE reference being 1.

In response to the QoE configuration subscription request, the SN will transmit a response (the first information) to the MN step 503, e.g., QoE configuration addition indication information indicating addition of QoE measurements to a UE or QoE configuration released indication information indicating release of QoE measurements to a UE. For example, the SN will report a QoE configuration addition indication to the MN in the case that the SN configures one or more QoE measurements to the UE. The SN will report a QoE configuration release indication to the MN in the case that the SN releases one or more QoE measurements to the UE. In the case that QoE reference(s) is indicated in the QoE configuration subscription request, only addition or release of the QoE measurement(s) associated with the indicated QoE reference(s) will be reported by the SN. In the case that no QoE reference is indicated in the QoE configuration subscription request, addition or release of any QoE measurement will be reported by the SN.

Based on the QoE configuration addition indication information and/or the QoE configuration released indication information, the RAN node will be aware which QoE measurement(s) has been configured to the UE, and will not configure the same QoE measurement to the UE, and accordingly no duplicated QoE measurement will be transmitted to the UE.

Similarly, compared with Scenario 1, descriptions on Scenario 4 are simplified to avoid unnecessary duplication. Persons skilled in the art should well know that some similar or identical details, specifically the information indicating the QoE measurement illustrated in Scenario 1 can also be applied to Scenario 4 in the same or similar way.

Besides, some embodiments of the present application mainly considering issue 2 are illustrated in the following. Similarly, compared with Scenario 1, descriptions on the following scenarios are simplified to avoid unnecessary duplication. Persons skilled in the art should well know that some similar or identical details, specifically the information indicating the QoE measurement illustrated in Scenario 1 can also be applied to the following in the same or similar way.

According to some embodiments of the present application (Scenario 5), a RAN node served as an MN will be responsible for RRC identifier value range (the second information), e.g., a measConfigAppLayerId value range allocation for QoE measurement either from the MN or the SN. For example, the whole value range of RRC identifiers, e.g., measConfigAppLayerIds is {0 . . . 63}. The MN may decide the value range used by the MN is (0 . . . 31), and the value range used by SN is (32 . . . 63), vice versa. Since different RRC identifier value ranges are used by the MN and SN, QoE measurements from the MN and from SN will not be allocated the same RRC identifiers. That is, the issues caused by different QoE measurements to the UE from the MN and SN with the same RRC identifiers will be avoided.

The MN will transmit information indicating a RRC identifier value range for QoE measurement to the SN, which can be transmitted on the MN's initiative or in response to a request from the SN. For example, if the SN decides to configure a QoE measurement, the SN may request a RRC identifier value range used by SN from the MN.

Exemplary message or signaling of transmitting the information indicating a RRC identifier value range is an S-NG-RAN Node Modification Request message or NG-RAN Node Addition Request message or the like. The information may explicitly indicate a RRC identifier value range for QoE measurement used by the SN, e.g., (32 . . . 63), or implicitly indicate a RRC identifier value range for QoE measurement used by the SN by indicating a RRC identifier value range for QoE measurement used by the MN, e.g., (0 . . . 31), or indicating both a RRC identifier value range used by the SN and a RRC identifier value range used by the MN, e.g., both (0 . . . 31) and (32 . . . 63).

When either the MN or the SN configures a QoE measurement to a UE, it will select a RRC identifier value within the corresponding value range. For example, when configuring a RRC identifier for a QoE measurement triggered by the SN, the SN will allocate a RRC identifier for the QoE measurement within the value range used by the SN. If a RRC identifier value range, e.g., measConfigAppLayerId range used by the SN is not received from the MN, the SN will not configure the QoE measurement for the UE.

Solutions illustrated in view of Scenario 5 can also solve the issues on RRC identifiers for RVQoE measurements. For example, the RRC identifier value range allocated to the MN can also be used as the third information for RVQoE measurement by the MN, and the RRC identifier value range allocated to the SN can also be used as the third information for RVQoE measurements by the SN.

Similar to Scenario 5, according to some embodiments of the present application (Scenario 6), a RAN node served as an MN will be responsible for allocating a RRC identifier value (the second information), e.g., measConfigAppLayerId for a QoE measurement configured by the SN.

For example, after receiving a QoE measurement, e.g., a management-based QoE measurement, the SN may transmit a request, e.g., QoE measurement identifier required information to the MN, requesting a RRC identifier for a QoE measurement. An exemplary request includes at least one of a QoE reference or service type. After receiving the request, the MN will allocate a RRC identifier, e.g., measConfigAppLayerId for the requested QoE measurement and transmit it to the SN. Then the SN will use the RRC identifier indicated by the MN for the QoE measurement.

In some embodiments of the present application, the SN may request a RRC identifier for a QoE measurement in an implicit manner. For example, as illustrated in Scenario 2, when the SN transmits QoE configuration request information with an SN RRC identifier to the MN while the MN does not allow the requested QoE measurement due to that the same RRC identifier has been allocated by the MN for a different QoE measurement, the MN may indicate another RRC identifier for the QoE measurement used by the SN.

Similarly, solutions illustrated in view of Scenario 6 can also solve the issues on RRC identifiers for RVQoE measurements. For example, the RRC identifier allocated to the SN by the MN can also be used as the third information for RVQoE measurements by the SN.

According to some embodiments of the present application (Scenario 7), the MN and SN can use independent RRC identifier for QoE measurement configuration, which is different from current RRC identifier.

For example, an independent RRC identifier (second information) may further include an index besides a measConfigAppLayerId, wherein the index for MN (also referred to as MN index) and that for SN (also referred to as SN index) are independent and different. Accordingly, the QoE measurement from the MN and SN to the UE can be uniquely identified according to the RRC identifier including an index and the measConfigAppLayerId. An exemplary index, e.g., MN index or SN index may be coded in an enumerated type or a bitstring type.

In another example, specific information as RRC identifier used in SN (second information) is defined, which means that the QoE measurement is configured by SN. For example, a specific information element (IE) is defined for RRC identifier used by SN. When the UE receives the specific information, the UE will determine that the associated QoE measurement is configured by the SN. A similar solution can also be applied to the MN in some embodiments of the present application.

Similarly, solutions illustrated in view of Scenario 7 can also solve the issues on RRC identifiers for RVQoE measurements. For example, the specific information designed for RRC identifier used by the SN can also be used as the third information for RVQoE measurements by the SN.

In addition, regarding RVQoE measurements, besides the above illustrated in Scenarios 1 to 7, the following will be further illustrated. Similarly, regarding the QoE measurement associated with the RV QoE measurement, what illustrated in Scenario 1 in details can also be applied to the following in the same or similar way.

According to some embodiments of the present application, the MN and SN can configure separate or independent RVQOE configurations either for signaling-based QoE measurement or management-based QoE measurement. How to coordinate RVQoE configurations between the MN and SN in both the two manners will be solved. The illustrated solutions for RVQoE measurements can be applied independent from the solutions for solving issues 1 and 2 or in combination with them.

In the case that RVQoE measurements (associated with signaling-based QoE measurement or management-based QoE measurement) are respectively configured by the MN and SN, issues similar to issue 2 illustrated above may happen. Thus, the MN and SN can be coordinated to use the RRC identifier for the RVQoE measurement as that illustrated in Scenarios 5 to 7 to solve such issues.

For example, one exemplary solution is similar to that illustrated in Scenario 5. For example, besides the embodiments illustrated in Scenario 5, in some embodiments, the MN is responsible for RRC identifier value range allocation for RVQoE measurement. When a RVQoE measurement to be configured by an MN or SN, it needs to select a RRC identifier within a corresponding value range for. The MN will allocate the value range of RRC identifier for RVQoE measurements used by SN. When the SN configures a RVQoE measurement to the UE, the SN will select a RRC identifier within the allocated value range. In lack of the RRC identifier value range from the MN, the SN cannot configure the RVQoE measurement for the UE.

Another exemplary solution is similar to that illustrated in Scenario 6. For example, besides the embodiments illustrated in Scenario 6, in some embodiments, when being triggered to configure a RVQoE measurement to the UE, the SN will request a RRC identifier for the RVQoE measurement from the MN, which may indicate at least one of the QoE reference or service type. In response to the request, the MN will allocate a RRC identifier, e.g., a measConfigAppLayerId for the RVQoE measurement and transmit it to the SN.

Another exemplary solution is similar to that illustrated in Scenario 7. For example, besides the embodiments illustrated in Scenario 7, in some embodiments, the MN and SN use independent RRC identifier for RVQoE measurement configurations. For example, the RVQoE measurement from the MN and SN to the UE can be uniquely identified according to a RRC identifier including an index and the measConfigAppLayerId. In another example, specific information as RRC identifier for RVQoE measurement used in SN is defined, which means that the RVQoE measurement is configured by the SN. A similar solution can also be applied to the RRC identifier for RVQoE measurement used the MN in some embodiments of the present application.

In the case that the MN and SN can only configure one (a single) RVQUE measurement for a same QoE measurement to the UE, when a RAN node, e.g., the MN have already configured the QoE measurement to the UE, the peer node, e.g., the SN may also need to configure a RVQoE measurement to the UE for collecting RVQoE measurement results. Thus, the peer node needs to know the RRC identifier of the QoE measurement for RVQOE measurement configuration, which can be solved by transmitting the RRC identifier of the configured QoE measurement by the RAN node to its peer RAN node (voluntary or in response to a request from the peer RAN node), or can be solved with solutions similar to that illustrated in Scenarios 1 to 3.

For example, one exemplary solution is similar to that illustrated in Scenario 1. For example, besides the embodiments illustrated in Scenario 1, in some embodiments, the application layer of the UE may provide a RRC identifier allocated on one RAN node of the QoE measurement to the RRC layer of the UE in other messages or scenarios, e.g., receiving one signaling-based QoE measurement from one RAN node. The RRC layer of the UE will report the RRC identifier allocated by the RAN node of the QoE measurement to the peer RAN node so that the peer RAN node knows that the RRC identifier configured by the RAN node for the QoE measurement. Accordingly, the peer RAN node can use the RRC identifier allocated by the RAN node for RVQoE configuration if necessary.

Another exemplary solution is similar to that illustrated in Scenario 2. For example, besides the embodiments illustrated in Scenario 2, in some embodiments, the SN may send QoE configuration request information to the MN to request whether a QoE measurement, e.g., a signaling-based QoE measurement is allowed or not. In the case that the SN RRC identifier is included in the QoE configuration request information and the requested QoE measurement is allowed, the MN may also store the SN RRC identifier and use it as the RRC identifier for RVQoE measurement for corresponding RVQoE measurement if necessary. In the case that the requested QoE measurement is not allowed, the MN may also indicate the MN RRC identifier of the QoE measurement to the SN. The SN may use the allocated RRC identifier by the MN as the third information for corresponding RVQoE configuration if necessary.

Yet another exemplary solution is similar to that illustrated in Scenario 3. For example, besides the embodiments illustrated in Scenario 3, in some embodiments, a RAN node, e.g., the MN sends QoE measurement configuration indication to the peer RAN node, e.g., the SN to indicate the QoE measurement configuration, e.g., a signaling-based QoE measurement has already been configured or will be configured to the UE. The MN may also include the allocated RRC identifier by the MN of the QoE measurement to the SN. The SN may use the allocated RRC identifier by the MN for RVQoE configuration if necessary.

Moreover, for the RVQoE measurement result generated by the UE, e.g., by the application layer of the UE, how the UE, e.g., the RRC layer selects the reporting leg, e.g. MCG or SCG, needs to be addressed.

In some embodiments of the present application, the RRC layer will select the at least one leg to report the RVQoE measurement results based on bearer types Besides the RVQUE measurement results, the application layer may also provide information of at least one of the DRB, QoS flow or PDU session, e.g., at least one of DRB identifier, QoS flow identifier or PDU session identifier. In the case that the at least one of DRB, QoS flow or PDU session is served by only one of the MCG (MCG bearer) or SCG (SCG bearer), the RRC layer will only report the RVQUE measurement results to corresponding one of the MN and the SN. In the case that the at least one of DRB, QoS flow or PDU session is served by both MCG and SCG, the RRC layer will report the RVQoE measurement results to both the MN and SN.

In some other embodiments of the present application, the network will configure the RVQoE measurement results reporting leg to the UE, e.g., reporting leg configuration information, which may be per DRB, QoS flow or PDU session etc. The UE will select the reporting leg according to the configuration.

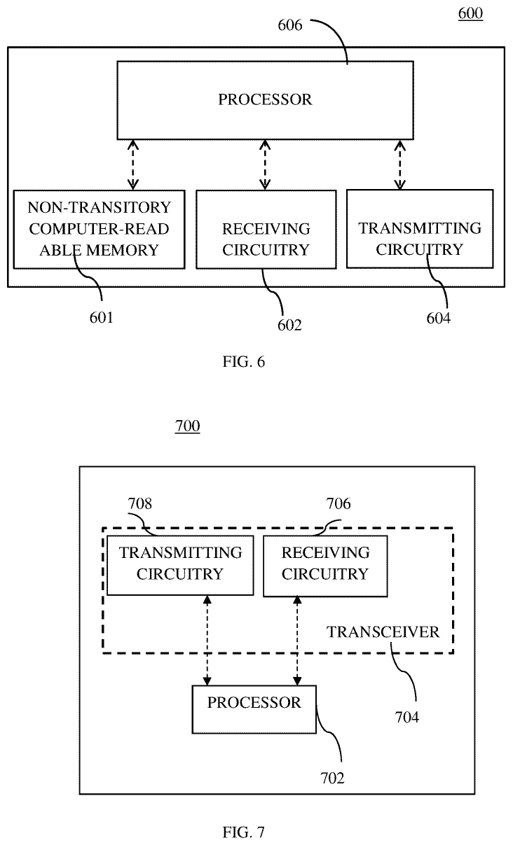

Besides methods, embodiments of the present application also propose an apparatus of supporting QoE measurement collection. For example, FIG. 6 is a block diagram of an apparatus of supporting QoE measurement collection according to some embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a RAN node or a terminal device (e.g., a UE) configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. The processor 606 may be a CPU, a DSP, a microprocessor etc. In certain embodiments of the present application, the apparatus 600 may further include an input device, a memory, and/or other components.

In some embodiments of the present application, the non-transitory computer-readable medium 601 may have stored thereon computer-executable instructions to cause the processor 606 to implement the method with respect to the RAN node, e.g., a MN or SN as described above. For example, the computer-executable instructions, when executed, cause the processor 606 interacting with receiving circuitry 602 and transmitting circuitry 604, so as to perform the steps with respect to a RAN node as depicted above.

In some embodiments of the present application, the non-transitory computer-readable medium 601 may have stored thereon computer-executable instructions to cause a processor to implement the method with respect to the terminal device as described above. For example, the computer-executable instructions, when executed, cause the processor 606 interacting with receiving circuitry 602 and transmitting circuitry 604, so as to perform the steps with respect to a UE as depicted above.

FIG. 7 illustrates a block diagram of an apparatus 700 of supporting QoE measurement reporting according to some other embodiments of the present application.

Referring to FIG. 7, the apparatus 700, e.g., a UE or a RAN node may include at least one processor 702 and at least one transceiver 704. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some embodiments of the present application, when the apparatus 700 is a RAN node, e.g., a MN or SN, the processor is configured to: receive information indicating at least one QoE measurement; and determine information associated with configurations of the at least one QoE measurement, wherein the information associated with configurations of the at least one QoE measurement includes at least one of: first information related to whether a same QoE measurement is configured to a UE by an MN or an SN, second information related to RRC identifiers for QoE measurements, or third information related to RRC identifiers for RVQoE measurements.

According to some other embodiments of the present application, when the apparatus 700 is a UE, the processor may be configured to: receive first QoE configuration information from a first radio access network (RAN) node; receive second QoE configuration information from a second RAN node; and transmit duplication indication information to at least one of the first RAN node or the second RAN node in response to that the first QoE configuration information and the second QoE configuration information are associated with a same QoE measurement. The duplication indication information indicates that at least one of the first QoE configuration information or the second QoE configuration information is ignored due to the first QoE configuration information and the second QoE configuration information being duplicated for a QoE measurement.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
receive first quality of experience (QoE) configuration information from a first radio access network (RAN) node;
receive second QoE configuration information from a second RAN node; and
transmit duplication indication information to at least one of the first RAN node or the second RAN node in response to the first QoE configuration information and the second QoE configuration information being associated with a same QoE measurement, wherein the duplication indication information indicates that at least one of the first QoE configuration information or the second QoE configuration information is ignored due to the first QoE configuration information and the second QoE configuration information being duplicated for a QoE measurement.

2. The UE of claim 1, wherein the at least one processor is further configured to, in a case that RAN visible QoE (RVQoE) measurement configuration information is also received, select, by a radio resource control (RRC) layer of the UE, at least one leg of a master node (MN) and a secondary node (SN) to report RVQoE measurement results.

3. A radio access network (RAN) node for wireless communication, comprising:
at least one memory; and
at least one processor coupled with the at least one memory and configured to cause the RAN node to:
receive information indicating at least one quality of experience (QoE) measurement; and
determine information associated with configurations of the at least one QoE measurement, wherein the information associated with configurations of the at least one QoE measurement includes at least one of: first information related to whether a same QoE measurement is configured to a user equipment (UE) by a master node (MN), or second information related to radio resource control (RRC) identifiers for QoE measurements.

4. The RAN node of claim 3, wherein, the RAN node is an MN and a peer node is a secondary node (SN), and the at least one processor is further configured to cause the RAN node to:
receive QoE configuration request information to request whether a QoE measurement is allowed from the SN; and
transmit the first information to the SN in response to the QoE configuration request information, wherein the first information is QoE configuration allowed indication information indicating that the QoE measurement is allowed or QoE configuration rejected indication information indicating that the QoE measurement is rejected.

5. The RAN node of claim 4, wherein an RRC identifier of the QoE measurement is allocated by the MN and transmitted to the SN with the QoE configuration allowed indication information, or is allocated by the SN and transmitted to the MN with the QoE configuration request information.

6. The RAN node of claim 3, wherein the at least one processor is further configured to cause the RAN node to:
transmit the first information to a peer node, wherein the first information is QoE measurement configuration indication information indicating that a QoE measurement has already been or will be configured to the UE by the RAN node.

7. The RAN node of claim 3, wherein the at least one processor is further configured to cause the RAN node to:
transmit, to a peer node, a QoE configuration subscription request to subscribe QoE measurements configured by the peer node; and
receive the first information from the peer node, wherein the first information is QoE configuration addition indication information indicating QoE measurements configured to the UE, or QoE configuration released indication information indicating released QoE measurements to the UE.

8. The RAN node of claim 3, wherein the RAN node is an MN and a peer node is a secondary node (SN), and the at least one processor is further configured to cause the RAN node to:
transmit the second information to the SN, wherein the second information indicates an RRC identifier value range for QoE measurements used by the SN.

9. The RAN node of claim 3, wherein the RAN node is an MN and a peer node is a secondary node (SN), and the at least one processor is further configured to cause the RAN node to:
receive a request for an RRC identifier for a QoE measurement from the SN; and
transmit the second information to the SN, wherein the second information indicates the RRC identifier for the QoE measurement.

10. The RAN node of claim 3, wherein the at least one processor is further configured to cause the RAN node to transmit the second information to the UE, and
in a case that the RAN node is an MN, the second information indicates measConfigAppLayerId and an MN index for a QoE measurement configured by the MN to the UE, and
in a case that the RAN node is a secondary node (SN), the second information indicates measConfigAppLayerId and an SN index for a QoE measurement configured by the SN to the UE.

11. The RAN node of claim 3, wherein the RAN node is an MN and a peer node is a secondary node (SN), and the at least one processor is further configured to cause the RAN node to:
transmit third information to the SN, wherein the third information indicates an RRC identifier value range for RAN visible QoE (RVQoE) measurements used by the SN.

12. The RAN node of claim 3, wherein the RAN node is a secondary node (SN) and a peer node is an MN, and the at least one processor is further configured to cause the RAN node to:
receive third information from the MN, wherein the third information indicates an RRC identifier value range for RAN visible QoE (RVQoE) measurements used by the SN.

13. The RAN node of claim 3, wherein the RAN node is an MN and a peer node is a secondary node (SN), and the at least one processor is further configured to cause the RAN node to:
receive from the SN, a request for an RRC identifier for a RAN visible QoE (RVQoE) measurement; and
transmit third information to the SN, wherein the third information indicates the RRC identifier for the RVQoE measurement.

14. The RAN node of claim 3, wherein the at least one processor is further configured to cause the RAN node to transmit third information to the UE, and
in a case that the RAN node is an MN, the third information indicates measConfigAppLayerId and an MN index for a RAN visible QoE (RVQoE) measurement configured by the MN to the UE, and
in a case that the RAN node is a secondary node (SN), the third information indicates measConfigAppLayerId and an SN index for a RVQoE measurement configured by the SN to the UE.

15. The RAN node of claim 3, wherein in a case that duplication indication information indicating that QoE configuration information from the RAN node is ignored due to being duplicated with other QoE configuration information for a same QoE measurement is received from the UE, the at least one processor is further configured to cause the RAN node to determine an RRC identifier of other QoE configuration information received with the duplication indication information as third information to be used for corresponding RAN visible QoE (RVQoE) measurement by the RAN node.

16. A method performed by a user equipment (UE), the method comprising:
receiving first quality of experience (QoE) configuration information from a first radio access network (RAN) node;
receiving second QoE configuration information from a second RAN node; and
transmit duplication indication information to at least one of the first RAN node or the second RAN node in response to the first QoE configuration information and the second QoE configuration information being associated with a same QoE measurement, wherein the duplication indication information indicates that at least one of the first QoE configuration information or the second QoE configuration information is ignored due to the first QoE configuration information and the second QoE configuration information being duplicated for a QoE measurement.

17. The method of claim 16, further comprising, in a case that RAN visible QoE (RVQoE) measurement configuration information is also received, selecting, by a radio resource control (RRC) layer of the UE, at least one leg of a master node (MN) and a secondary node (SN) to report RVQoE measurement results.

18. A method performed by a radio access network (RAN), the method comprising:
receiving information indicating at least one quality of experience (QoE) measurement; and
determining information associated with configurations of the at least one QoE measurement, wherein the information associated with configurations of the at least one QoE measurement includes at least one of: first information related to whether a same QoE measurement is configured to a user equipment (UE) by a master node (MN) or second information related to radio resource control (RRC) identifiers for QoE measurements.

19. The method of claim 18, further comprising:
transmitting the first information to a peer node, wherein the first information is QoE measurement configuration indication information indicating that a QoE measurement has already been or will be configured to the UE by the RAN node.

20. The method of claim 18, wherein the RAN node is an MN and a peer node is a secondary node (SN), the method further comprising:
receiving a request for an RRC identifier for a QoE measurement from the SN; and
transmitting the second information to the SN, wherein the second information indicates the RRC identifier for the QoE measurement.
